(19) United States
(12) Patent Application Publication
(10) Pub. No.: US 2014/0341585 A1
(43) Pub. Date: Nov. 20, 2014

(54) WIRELESS RELAY SYSTEM AND EMPLOYMENT METHOD THEREOF

(71) Applicants: Seoby Electronics Co., Ltd., Anyang city (KR); Next Generation Home Products, Port Richey, FL (US)

(72) Inventor: Sung Sub LEE, Anyang-si (KR)

(73) Assignees: Seoby Electronics Co., Ltd., Anyang city (KR); Next Generation Home Products, Port Richey, FL (US)

(21) Appl. No.: 14/278,026

(22) Filed: May 15, 2014

(30) Foreign Application Priority Data
May 16, 2013 (KR) 10-2013-0055672

(51) Int. Cl. G08C 23/04; H04B 10/291

(52) U.S. Cl. CPC G08C 23/04; H04B 10/291
USPC 398/106

(57) ABSTRACT

The wireless relay system may include: at least one control target device installed in a home or an office; a smart device in which a specific App provided from an application market is downloaded and installed; and a wireless extender, which is connected with the at least one control target device through Infrared communication and connected with the smart device through Bluetooth communication or WiFi communication, matching control codes and specific codes requested by the specific App of the smart device and transmitting an IR signal corresponding to the control codes for controlling the at least one control target device.

### CROSS-REFERENCE TO RELATED APPLICATION

This application claims priority to and the benefit of Korean Patent Application No. 10-2013-0055672 filed in the Korean Intellectual Property Office on May 16, 2013, the entire contents of which are incorporated herein by reference.

### BACKGROUND OF THE INVENTION

(a) Field of the Invention

The present invention relates to a wireless relay system and an employment method thereof. More particularly, the present invention relates to a wireless relay system and an employment method for interworking with an App of a smart device and controlling operations of various devices installed in a home or an office by wireless without distance limitation.

(b) Description of the Related Art

Various devices such as set-top boxes, televisions, digital video disc (DVD) players, video systems, air conditioners, audio systems, lamp turn on/off devices, curtain shutters, window openers, and gate openers have been installed in homes.

The various devices are operated by the user's direct manipulation or by manipulating a corresponding remote controller.

Generally, infrared (IR) communication is short range communication, and therefore it has distance limitations and is weak to neighboring obstacles.

In order to operate a single device installed in a home, for example an air conditioner, it is required for the user to move closer to a space where the air conditioner is installed, and to perform the desired operation since the desired operation can only be controlled in the space where the air conditioner is installed or a space that can receive a control signal of the remote controller.

Also, in order to control a single device, a remote controller corresponding thereto should be used and hence the remote controller management is inconvenient, and batteries are used to thus generate environmental pollution.

### PRIOR ART

### Patent Document

Patent Document 1) Korean Patent Laid-Open Publication No. 10-2004-0104871 (2004.12.13.)

Patent Document 2) Korean Patent Laid-Open Publication No. 10-2012-0126821 (2012.11.21.)

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a wireless relay system and an employment method thereof having advantages of interworking with an application of a smart device and controlling various devices installed in a home or an office by wireless without distance limitation.

A wireless relay system according to an exemplary embodiment of the present invention may include: at least one control target device installed in a home or an office; a smart device in which a specific App provided from an application market is downloaded and installed; and a wireless extender, which is connected with the at least one control target device through Infrared communication and connected with the smart device through Bluetooth communication or WiFi communication, matching control codes and specific codes requested by the specific App of the smart device, and controlling the at least one control target device by transmitting a corresponding IR signal to the at least one control target device.

The specific codes which are stipulated between the smart device and the wireless extender may be code values capable of recognizing key values for each of buttons configured in the specific App.

The wireless extender may be store integrated remote control codes in a memory.

The wireless extender may analyze specific codes according to key values provided from the smart device, match control codes and the model of the at least one control target device, and transmit the control codes for controlling the at least one control target device by using IR communication to perform predetermined operations.

The wireless extender may provide the control result of the at least one control target device to the smart device to display the control result on the screen of the smart device.

The wireless extender may be connected to a computer or an Internet network to upgrade firmware and integrated remote control codes.

The wireless extender may learn and store control codes corresponding to a button inputted from an external remote controller if the smart device is in a learning mode.

The wireless extender may learn and store the control codes by inputting the same button two times if the smart device is in the learning mode.

A wireless extender according to an exemplary embodiment of the present invention may include: a wireless communicator, connected to the smart device through wireless communication, and receiving stipulated specific codes; a memory storing integrated remote control codes in a designated region; a USB port connecting to an adaptor or a USB port of a computer to supply power and connecting to the computer or an Internet network to upgrade firmware and integrated remote control codes; a controller recognizing stipulated specific codes provided from the wireless communicator and matching control codes and a model of the at least one control target device; and an IR transmitter transmitting control codes applied from the controller to the at least one control target device through IR communication.

The wireless communicator may be connected to a smart device through Bluetooth communication or WiFi communication to receive stipulated specific codes corresponding to key values for each of buttons configured in a specific App.

The IR transmitter may include at least one infrared LED in order to extend a transmission angle to 360 degrees.

An employment method of a wireless relay system according to an exemplary embodiment of the present invention may include: installing a specific App in a smart device; performing wireless communication between the smart device and a wireless extender; searching control codes from integrated remote control codes which are stored in the wireless extender to set control codes of at least one control target device; receiving stipulated specific codes corresponding to key values for each of buttons configured in the specific App; analyzing specific codes to match control codes and a model of the at least one control target device; and controlling the at least one control target device by transmitting a corresponding IR signal to the at least one control target device.

The method may further include providing the control result of the at least one control target device to the smart device to display the control result on the screen of the smart device.

### BRIEF DESCRIPTION OF THE DRAWINGS

FIG. 1 is a schematic diagram of a wireless relay system according to an exemplary embodiment of the present invention.

FIG. 2 is a block diagram of a wireless extender according to an exemplary embodiment of the present invention.

FIG. 3 is a flowchart of an employment method of a wireless relay system according to an exemplary embodiment of the present invention.

FIG. 4 shows a wallpaper of a smart device interworked with a wireless extender according to an exemplary embodiment of the present invention.

FIG. 5 shows a wireless connection state displayed on a screen of a smart device according to an exemplary embodiment of the present invention.

FIG. 6 shows available devices displayed on a screen of a smart device according to an exemplary embodiment of the present invention.

FIG. 7 shows a control code searching process for each model of a control target device according to an exemplary embodiment of the present invention.

FIG. 8 shows an auto-scanning process for each model of a control target device according to an exemplary embodiment of the present invention.

FIG. 9 shows a button configuration displayed on a smart device for controlling a control target device according to an exemplary embodiment of the present invention.

FIG. 10 shows a control code learning process for a wireless extender according to an exemplary embodiment of the present invention.

### DESCRIPTION OF SYMBOLS

100: Smart device 200: Wireless extender
300: Target control device 201: Wireless communicator
203: USB port 205: Memory
207: Controller 209: IR transmitter

### DETAILED DESCRIPTION OF THE EMBODIMENTS

An exemplar embodiment of the present invention will hereinafter be described in detail with reference to the accompanying drawings.

As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification.

In addition, each configuration shown in the drawings is arbitrarily shown for better understanding and ease of description, but the present invention is not limited thereto.

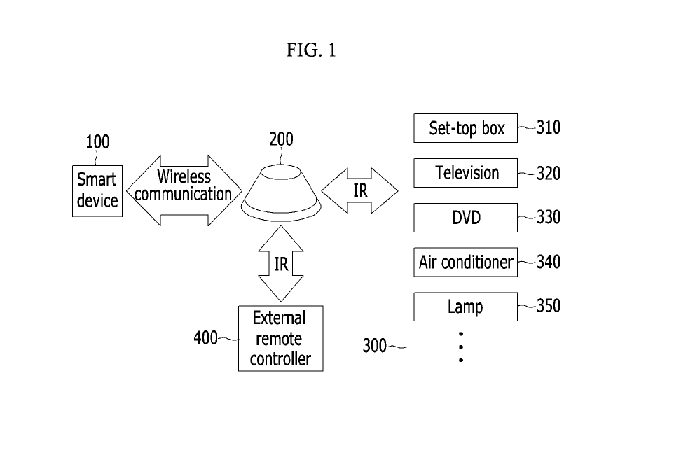

FIG. 1 is a schematic diagram of a wireless relay system according to an exemplary embodiment of the present invention.

Referring to FIG. 1, a wireless relay system according to an exemplary embodiment of the present invention includes a smart device 100, a wireless extender 200, and a control target device 300.

The smart device 100 may include a smart phone and a smart pad. A specific App is downloaded from an application market (e.g., an App store or an Android Market), and is installed in order to control the operation of the control target device 300 through the wireless extender 200.

The specific App is an application program with contents according to an exemplary embodiment of the present invention, which are executed using various software and hardware resources of the smart device 100.

The smart device 100 is connected with the wireless extender 200 through Bluetooth communication or WiFi communication. The smart device 100 transmits stipulated specific codes corresponding to key values for each of buttons configured in the specific APP to the wireless extender 200.

The stipulated specific codes may be predetermined code values in order to recognize key values for each of buttons configured in the specific APP, and may be configured with hexa-codes.

The communication method between the wireless extender 200 and the control target device 300 may be any one of infrared (IR) communication, Bluetooth communication, WiFi communication, Radio Frequency (RF) communication, and Zigbee communication.

The wireless extender 200 stores integrated remote control codes. Control codes corresponding to the control target device 300 are searched from the integrated remote control codes, and are set for controlling the control target device 300 by the smart device 100.

The wireless extender 200 analyzes specific codes according to key values provided from the smart device 100, matches control codes and the model of the predetermined control target device 300, and transmits the control codes for controlling the control target device 300 by using IR communication to perform predetermined operations.

The wireless extender 200 provides the control result of the control target device 300 to the smart device 100 to display the control result on the screen of the smart device 100.

The wireless extender 200 is connected to a computer or an Internet network to upgrade firmware and integrated remote control codes.

The control target device 300 may include a set-top box 310, a television 320, a DVD 330, an air conditioner 340, a lamp 350, an audio system, and the like.

The control target device 300 is generally sold in stores and is not a core element, and thus a detailed description thereof will be omitted.

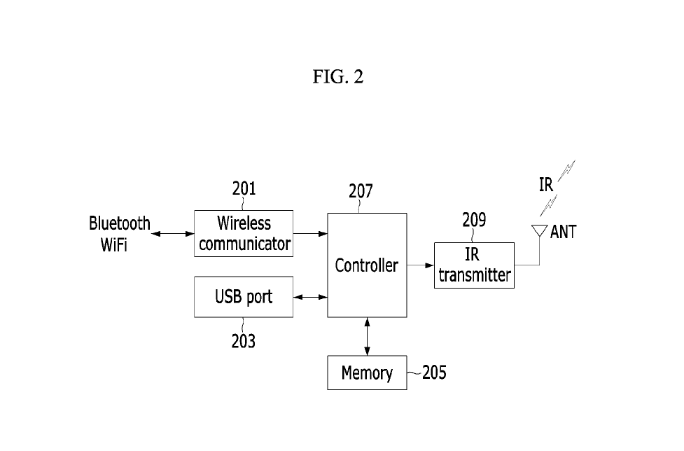

FIG. 2 is a block diagram of a wireless extender according to an exemplary embodiment of the present invention.

Referring to FIG. 2, the wireless extender according to the present invention includes a wireless communicator 201, a USB port 203, a memory 205, a controller 207, and an IR transmitter 209.

The wireless communicator 201 receives stipulated specific codes provided from the smart device 100 through Bluetooth communication or WiFi communication, and provides the stipulated specific codes to the controller 207.

In addition, when the control target device 300 is controlled by the controller 207, the wireless communicator 201 provides the control result as stipulated specific codes.

The USB port 203 is connected to an adaptor or a USB port of a computer and supplies power to operate the wireless extender 200.

In addition, the USB port 203 is connected to a computer or an Internet network to upgrade firmware and integrated remote control codes.

The memory 205 stores integrated remote control codes in a designated region.

The controller 207 recognizes stipulated specific codes provided from the wireless communicator 201. When stipulated specific codes for setting control codes are recognized, the controller 207 searches for integrated remote control codes stored in the memory 205 and sets control codes corresponding to the model of the control target device 300.

In addition, when stipulated specific codes for controlling the control target device 300 are recognized, the controller 207 matches predetermined control codes and the model of the control target device 300, and transmits the control codes through the IR transmitter 209.

The IR transmitter 209 transmits control codes applied from the controller 207 to the control target device 300 through IR communication in order to control the control target device 300.

The IR transmitter 209 includes at least one infrared LED in order to extend a transmission angle to 360 degrees, and thus the control target device 300 installed in any position can be controlled.

Hereinafter, an employment method of a wireless relay system according to an exemplary embodiment of the present invention will be described.

In order to control the control target device 300 through the wireless extender 200, an App capable of executing a multipurpose remote controller function should be installed in the smart device 100.

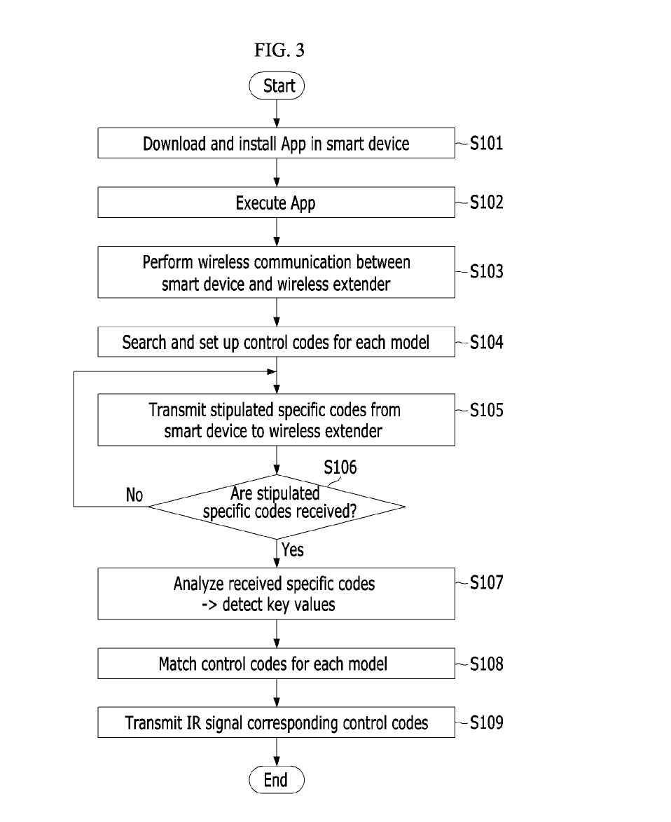

As shown in FIG. 3, the smart device 100 accesses the App store or the Android Market to download the specific App capable of executing the multipurpose remote controller function, and installs it at step S101.

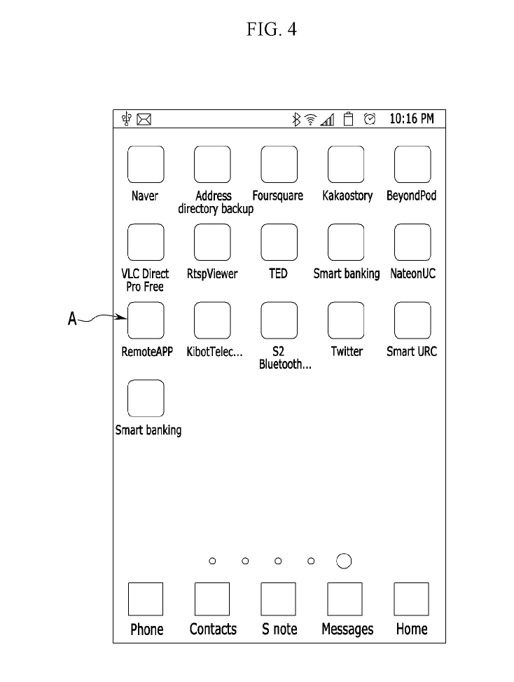

As shown in FIG. 4, an icon is generated on the screen of the smart device 100 as the specific App capable of executing the multipurpose remote controller function is downloaded. When the icon is touched to execute the specific App at step S102, the smart device 100 performs wireless communication with the wireless extender 200 at step S103.

At this time, in a case that the wireless communication method is Bluetooth communication, the smart device 100 determines whether a state of Bluetooth communication is in an activated state. If the state of Bluetooth communication is in an inactivated state, the smart device 100 changes the state of Bluetooth communication from the inactivated state to the activated state.

In addition, in a case that the wireless communication method is WiFi communication, the smart device 100 determines whether a state of WiFi communication is in an activated state. If the state of WiFi communication is in an inactivated state, the smart device 100 changes the state of WiFi communication from the inactivated state to the activated state.

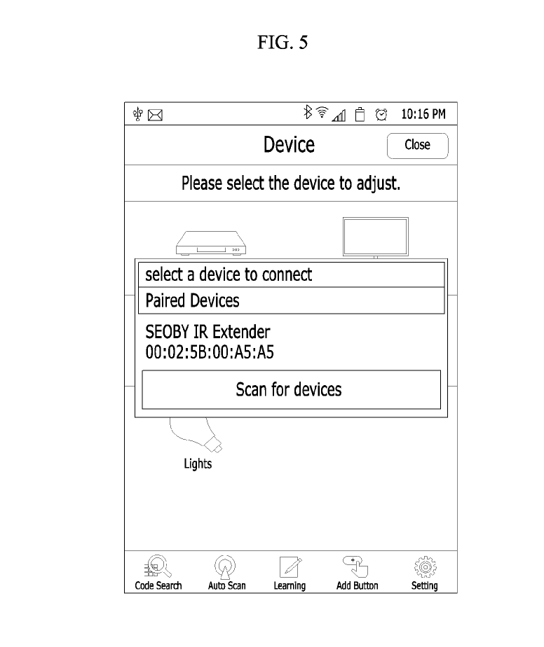

As shown in FIG. 5, the smart device 100 searches for various devices that are connected through Bluetooth communication and provides a corresponding list.

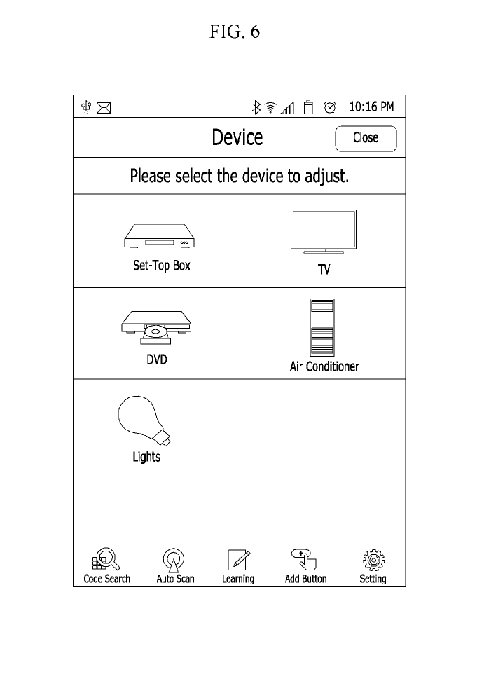

Accordingly, when “IR Extender” which is the wireless extender 200 is selected, information of control target devices (e.g., a set-top box, a TV, a DVD, an air conditioner, and a lamp) is displayed on the screen of the smart device 100 through the wireless extender 200, as shown in FIG. 6.

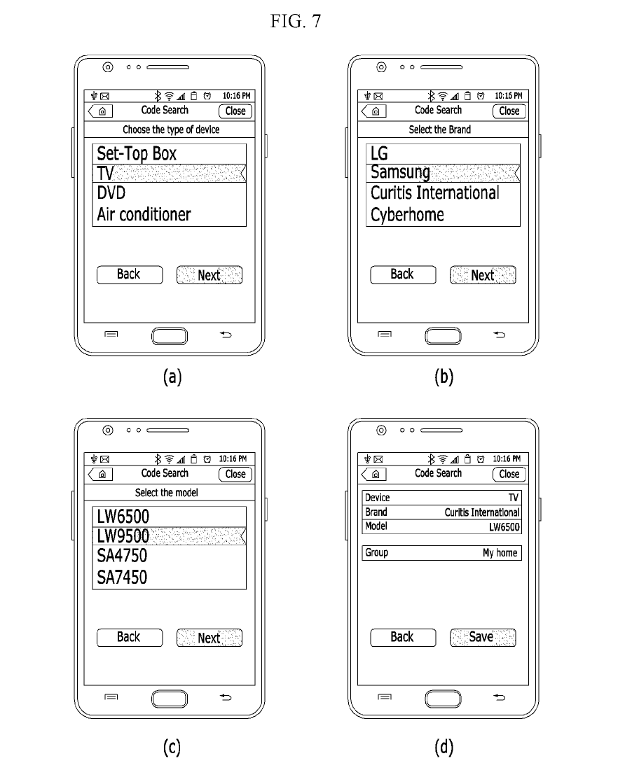

As shown in FIG. 6, buttons are provided in a lower end of the screen of the smart device 100 in order to set control codes according to the model of the control target device. When “Code Search” is selected from the buttons, information of the control target devices whose control codes will be set up is provided as shown in FIG. 7 (a).

When “TV” is selected from the information of the control target devices in FIG. 7 (a), manufacturer information of the corresponding product is provided as shown in FIG. 7 (b). When a specific manufacturer is selected, model information of the corresponding manufacturer is provided as shown in FIG. 7 (c). When a specific model is selected, control codes corresponding to the model are set up as shown in FIG. 7 (d).

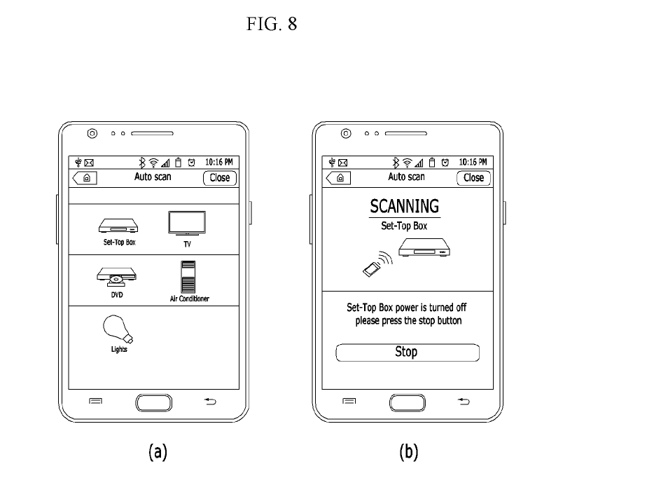

In addition, when “Auto Scan” is selected from the buttons as shown in FIG. 6, information of the control target devices whose control codes will be set up is provided as shown in FIG. 8 (a).

When “Set-Top box” is selected from the information of the control target devices in FIG. 8 (a), a response of the corresponding control target device is detected during auto scanning. Control codes of the corresponding control target device is set up automatically if the response is detected.

Through the above procedure, the control codes according to the model of the control target device are searched and are set up at step S104.

While the control codes according to the model of the control target device are set between the smart device 100 and the wireless extender 200, the smart device 100 transmits stipulated specific codes to the wireless extender 200 through Bluetooth communication or WiFi communication at step S105. The controller 200 determines whether the stipulated specific codes are received at step S106.

At the step S106, if the stipulated specific codes are received, the controller 207 analyzes the received specific codes and detects key values at step S107. The controller 207 matches control codes and the model of the control target device according to the detected key values at step S108.

The controller 207 transmits the control codes matching with the detected key values as an IR signal to the control target device 300 through the IR transmitter 209 in order to control the control target device 300 at step S109.

While the control codes according to the model of the control target device are set between the smart device 100 and the wireless extender 200, for example, the operation of controlling the set-top box is as described hereinafter.

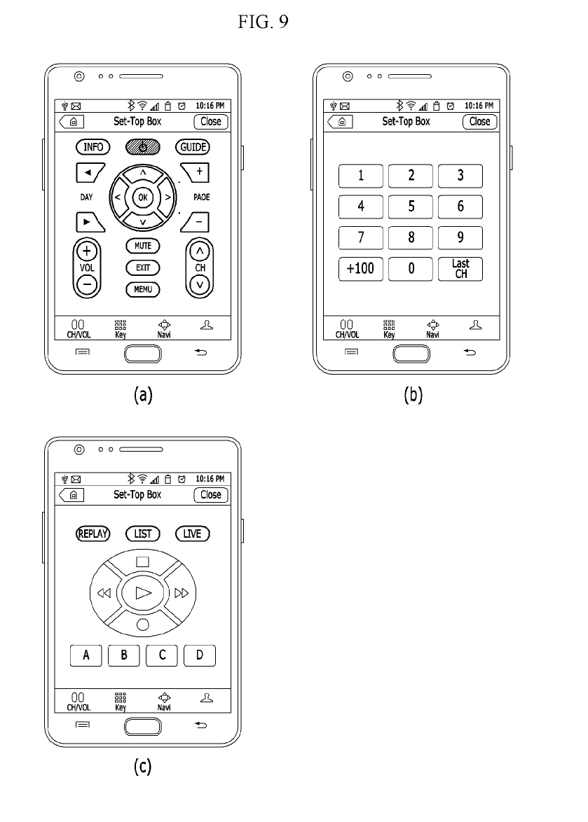

As shown in FIG. 6, when “Set-Top Box” is touched on the screen of the smart device 100, a main screen including function keys is provided as shown in FIG. 9 (a). The function keys include a power key, a mute key, a menu key, a volume up/down key, a channel up/down key, a direction key for selecting one of an upper, a lower, a left, and a right direction, and the like.

When “key” menu which is provided in the lower end of the screen is touched in FIG. 9 (a), number keys (0-9) for selecting a channel and an extending key such as +100 are provided as shown in FIG. 9 (b). When the “Navi” menu is touched, function keys for controlling video contents of the set-top box are provided as shown in FIG. 9 (c).

When the power key is touched in FIG. 9 (a), stipulated specific codes related to the power key are transmitted to the wireless extender 200 through Bluetooth communication or WiFi communication.

The controller 207 receives the stipulated specific codes related to the power key from the smart device 100 and analyzes the stipulated specific codes to extract the power key values.

After that, the controller 207 matches control codes related to the power key and model of the set-top box and provides the control codes to the IR transmitter 209.

Accordingly, the IR transmitter 209 transmits an IR signal corresponding to the control codes related to the power key of the set-top box in order to turn on/off the set-top box according to control of the controller 207.

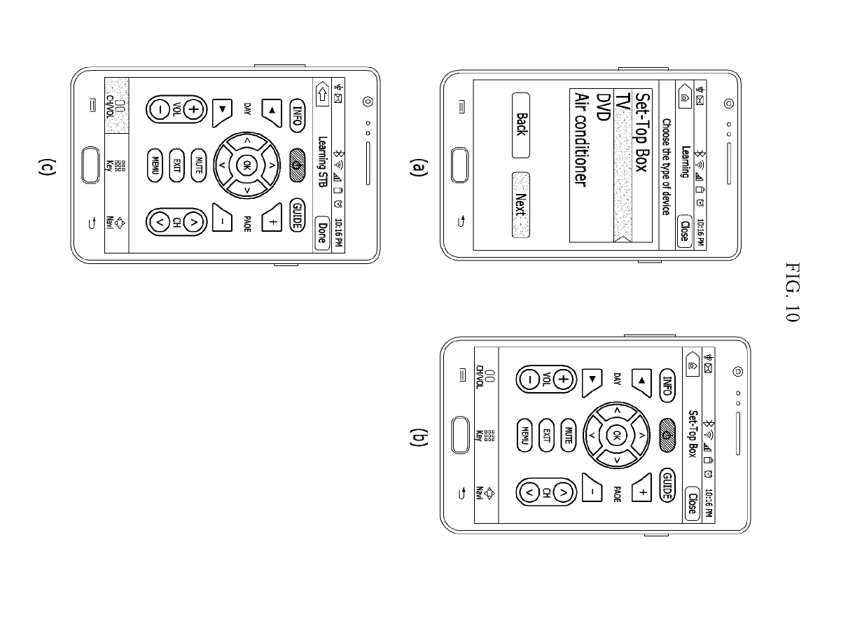

When the “Learning” menu which is provided in the lower end of the screen in FIG. 6 is touched for learning control codes of an unregistered control target device, the screen on which devices (e.g., a set-top box, a TV, a DVD, and an air conditioner) for learning the control codes is provided as shown in FIG. 10 (a).

In the provided screen of FIG. 10 (a), when the “Set-Top Box” is selected for learning control codes and the “Next” button is selected, a screen of a remote controller capable of controlling the set-top box is provided as shown in FIG. 10 (b).

When a power button 10-1 which is to be learned is selected, the color of the power button 10-1 is changed as shown in FIG. 10 (c).

When the user pushes the power button of an external remote controller 400 which is to be learned, the external remote controller 400 transmits a corresponding first IR signal to the wireless extender 300.

When the first IR signal is received, a corresponding message box may be displayed in the left upper end of the application screen of the smart device 100.

When a confirmation button (“OK” button) is selected, the message box disappears. In this state, when the user pushes the same button (power button) of the external remote controller 400, the external remote controller 400 transmits a second IR signal to the wireless extender 300.

When the second IR signal is received, a corresponding message box may be displayed in the left upper end of the application screen of the smart device 100, and when a confirmation button (“OK” button) is selected, the message box disappears.

Through the above process of learning the single button two times, the controller 207 learns and stores control codes of the corresponding button.

Control codes corresponding to all buttons of the external remote controller 400 are learned in the same process as described above.

In addition, when the “Add Button” menu which is provided in the lower end of the screen of FIG. 6 is selected, a new menu tab is added. The user can set positions of buttons to be configured on the new menu tab and set functions of buttons by using the learning function.

At this time, the user can desirably set the configuration and positions of the buttons.

As described above, it is possible to control various devices installed in a home or an office without distance limitation through the portable smart device 100. The user does not need to manage several controllers corresponding to each of the various devices.

In addition, there is the advantage that the cost can be reduced by preventing indiscriminate use of batteries.

Even though a new device is added, the new device is stably controlled according to an upgrade of firmware and control codes.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A wireless relay system, comprising:
at least one control target device installed in a home or an office;
a smart device in which a specific App provided from an application market is downloaded and installed; and
a wireless extender, which is connected with the at least one control target device through Infrared communication and connected with the smart device through Bluetooth communication or WiFi communication, matching control codes and specific codes requested by the specific App of the smart device, and controlling the at least one control target device by transmitting a corresponding IR signal to the at least one control target device.

2. The wireless relay system of claim 1, wherein the specific codes which are stipulated between the smart device and the wireless extender are code values capable of recognizing key values for each of buttons configured in the specific App.

3. The wireless relay system of claim 1, wherein the wireless extender stores integrated remote control codes in a memory.

4. The wireless relay system of claim 1, wherein the wireless extender analyzes specific codes according to key values provided from the smart device, matches control codes and the model of the at least one control target device, and transmits the control codes for controlling the at least one control target device by using IR communication to perform predetermined operations.

5. The wireless relay system of claim 1, wherein the wireless extender provides the control result of the at least one control target device to the smart device to display the control result on the screen of the smart device.

6. The wireless relay system of claim 1, wherein the wireless extender is connected to a computer or an Internet network to upgrade firmware and integrated remote control codes.

7. The wireless relay system of claim 1, wherein the wireless extender learns and stores control codes corresponding to a button inputted from an external remote controller if the smart device is in a learning mode.

8. The wireless relay system of claim 7, wherein the wireless extender learns and stores the control codes by inputting the same button two times if the smart device is in the learning mode.

9. The wireless relay system of claim 1, wherein the wireless extender comprises:
a wireless communicator, connected to the smart device through a wireless communication, and receiving stipulated specific codes;
a USB port connecting to an adaptor or a USB port of a computer to supply power and connecting to the computer or an Internet network to upgrade firmware and integrated remote control codes;
a memory storing integrated remote control codes in a designated region;
a controller recognizing stipulated specific codes provided from the wireless communicator and matching control codes and a model of the at least one control target device; and
an IR transmitter transmitting control codes applied from the controller to the at least one control target device through IR communication.

10. The wireless relay system of claim 9, wherein the IR transmitter includes at least one infrared LED in order to extend a transmission angle to 360 degrees.

11. A wireless extender, comprising:
a wireless communicator, connected to the smart device through wireless communication, and receiving stipulated specific codes;
a memory storing integrated remote control codes in a designated region;
a USB port connecting to an adaptor or a USB port of a computer to supply power and connecting to the computer or an Internet network to upgrade firmware and integrated remote control codes;
a controller recognizing stipulated specific codes provided from the wireless communicator and matching control codes and a model of the at least one control target device; and
an IR transmitter transmitting control codes applied from the controller to the at least one control target device through IR communication.

12. The wireless extender of claim 11, wherein the wireless communicator is connected to a smart device through Bluetooth communication or WiFi communication to receive stipulated specific codes corresponding to key values for each of buttons configured in a specific App.

13. The wireless extender of claim 11, wherein the IR transmitter includes at least one infrared LED in order to extend a transmission angle to 360 degrees.

14. An employment method of a wireless relay system, comprising:
installing a specific App in a smart device;
performing wireless communication between the smart device and a wireless extender;
searching control codes from integrated remote control codes which are stored in the wireless extender to set control codes of at least one control target device;
receiving stipulated specific codes corresponding to key values for each of buttons configured in the specific App;
analyzing specific codes to match control codes and a model of the at least one control target device; and
controlling the at least one control target device by transmitting a corresponding IR signal to the at least one control target device.

15. The employment method of claim 14, further comprising providing the control result of the at least one control target device to the smart device to display the control result on the screen of the smart device.
